(19) United States
(12) Patent Application Publication
(10) Pub. No.: US 2020/0293953 A1
(43) Pub. Date: Sep. 17, 2020

(54) RIDE REQUEST EVALUATION SYSTEMS AND METHODS

(71) Applicant: Ford Global Technologies, LLC, Dearborn, MI (US)

(72) Inventors: Sakthi Narayanan Balasubramanian, Chennai (IN); Shounak Athavale, San Jose, CA (US); Romil Shah, Santa Clara, CA (US); Stuti Vishwabhan, San Jose, CA (US)

(73) Assignee: Ford Global Technologies, LLC, Dearborn, MI (US)

(21) Appl. No.: 16/353,948

(22) Filed: Mar. 14, 2019

(51) Int. Cl. G06Q 10/02; G06Q 50/30; G06Q 30/02; G01C 21/34

(52) U.S. Cl. CPC G06Q 10/02; G01C 21/3469; G06Q 30/0284; G06Q 50/30

(57) ABSTRACT

Exemplary embodiments described in this disclosure generally pertain to ride request evaluation systems and methods that assist a driver of a ride automobile to make a decision on whether to accept or decline a ride request. An exemplary ride request evaluation system includes a computer that evaluates a profitability or a loss associated with accepting the ride request. The evaluation may be carried out based in part on a cost factor that is calculated using parameters such as a distance to a destination indicated in the ride request, a time of day for executing the ride request, a fuel consumption rate of a ride automobile, and/or an operational condition of the ride automobile. In one embodiment, the computer is located in a device that is operated by the driver. An installed application displays the result of the evaluation to assist the driver in deciding whether to accept or decline the ride request.

### FIELD OF THE DISCLOSURE

This disclosure generally relates to ride services, and more particularly relates to systems and methods that assist a driver in determining a response to a ride request.

### BACKGROUND

Ride services such as Uber™ and Lyft™ have proliferated over the last few years. The automobiles used for providing these types of ride services are typically owned and operated by drivers who voluntarily enroll in a particular ride service and are provided with a ride application that is executed on a personal device such as a smartphone or a tablet computer. Telephone operators of the ride service receive ride requests originated by members of the general public and pass on these ride requests to various drivers enrolled in the ride service. Each driver has an option whether to accept or to ignore a ride request. The driver often makes a decision based on factors such as financial need, experience, and convenience. However, a decision based on such parameters may turn out to be financially unprofitable to the driver. For example, the driver may have a pressing financial need that makes the driver accept a ride request from a customer located at a geographically distant pick-up location. Various expenses incurred by the driver in driving over to the pick-up location may partially or completely eat into any profit that the driver may make. Furthermore, the time spent on providing the ride to the customer from the distant location may have been better spent in catering to other more profitable rides. It would therefore be helpful if a driver of a ride service had a tool that would allow the driver to make an informed decision on whether to accept or turn down a ride request.

### BRIEF DESCRIPTION OF THE DRAWINGS

A detailed description is set forth below with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 shows an exemplary ride request evaluation system in accordance with an embodiment of the disclosure.

FIG. 2 shows some exemplary functional blocks of a device containing a ride request evaluation system in accordance with an embodiment of the disclosure.

FIG. 3 shows some exemplary functional blocks of a computer system used by a ride service operator to offer a ride request evaluation in accordance with an embodiment of the disclosure.

FIG. 4 shows a flowchart that illustrates an exemplary method for evaluating a ride request in accordance with an embodiment of the disclosure.

FIG. 5 shows a table of various exemplary parameters that may be utilized by a ride request evaluation system in accordance with an embodiment of the disclosure.

### DETAILED DESCRIPTION

The disclosure will be described more fully hereinafter with reference to the accompanying drawings, in which exemplary embodiments of the disclosure are shown. This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below has been presented for the purposes of illustration and is not intended to be exhaustive or to be limited to the precise form disclosed. It should be understood that alternate implementations may be used in any combination desired to form additional hybrid implementations of the present disclosure. For example, any of the functionality described with respect to a particular device or component may be performed by another device or component. Furthermore, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments.

Certain words and terms are used herein solely for convenience, and such words and terms should be interpreted as referring to various objects and actions that are generally understood in various forms and equivalencies by persons of ordinary skill in the art. For example, the phrase “ride service” as used herein refers to various types of transportation services such as taxi services, limousine services, shuttle services, carpool services, and rideshare services such as Uber™ and Lyft™. A “ride request” is originated by a ride customer who may be alternatively referred to herein as a “user” of a device, a “ride automobile” is any type of transportation vehicle that is used to provide ride services, and a “driver” of a ride automobile is a person who uses the automobile to offer his/her driving services to customers of a ride service operator. Furthermore, it should be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

In terms of a general overview, certain embodiments described in this disclosure are directed to ride request evaluation systems and methods that assist a driver of a ride automobile to make a decision on whether to accept or decline a ride request. An exemplary ride request evaluation system includes a computer that evaluates a profitability or a loss associated with accepting the ride request. The evaluation may be carried out based in part on a cost factor that is calculated using parameters such as a distance to a destination indicated in the ride request, a time of day for executing the ride request, a fuel consumption rate of a ride automobile, and/or an operational condition of the ride automobile. In one exemplary embodiment, the computer is a part of a device such as a smartphone, a laptop computer, or a tablet that is operated by the driver. An application that is installed in the device displays the result of the evaluation to assist the driver in deciding whether to accept or decline the ride request.

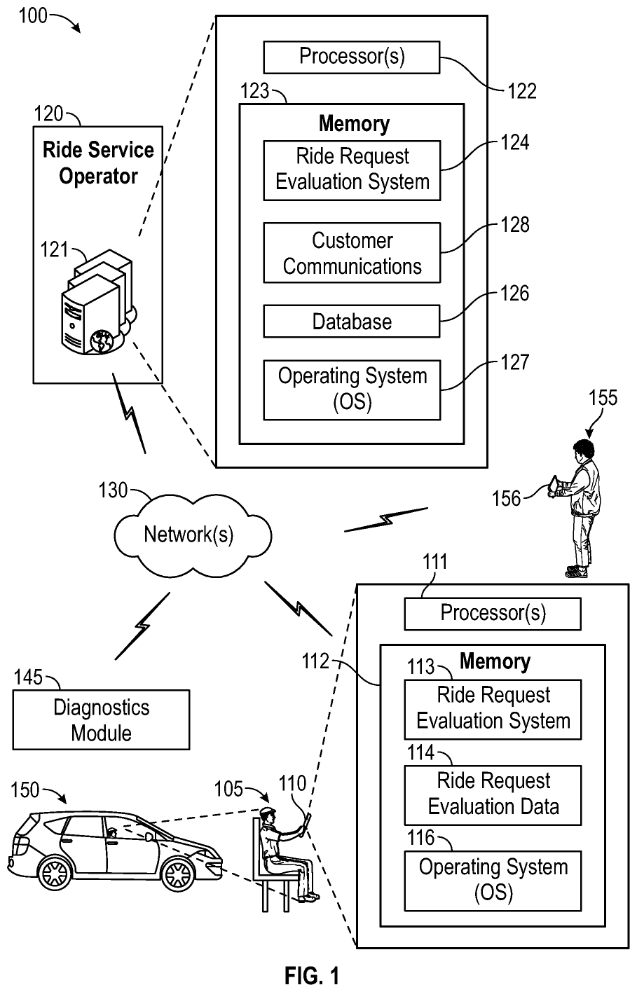

FIG. 1 shows an exemplary ride request evaluation system 100 in accordance with an embodiment of the disclosure. The system 100 may include a ride service operator 120 that uses a computer system 121 to execute various operations of a ride service. The computer system 121 may include several types of computers such as servers and clients, which may be communicatively coupled to each other via a network 130 such as a local area network (LAN) or a wide area network (WAN). One or more drivers of ride service automobiles, such as a driver 105 of a ride automobile 150, may communicate with the ride service operator 120 via the network 130. The network 130 may include any one or a combination of various networks, such as a telephone network, a cellular network, a cable network, a wireless network, and/or private/public networks such as the Internet. In some instances, the network 130 may support communication technologies such as Bluetooth, cellular, near-field communication (NFC), Wi-Fi, and/or Wi-Fi direct.

The driver 105 may use a device 110 to communicate with the ride service operator 120. The device 110 may be any of various types of devices such as a smartphone, a tablet, or a laptop running a ride request evaluation system 113. The ride request evaluation system 113 may be implemented in the form of an application that is provided by the ride service operator 120 or an application provided by a vendor and customized by the ride service operator 120. The device 110 may include several components such as a processor 111 and a memory 112. The memory 112, which is one example of a non-transitory computer-readable medium, may be used to store the ride request evaluation system 113, ride request evaluation data 114, and an operating system (OS) 116. A few examples of the type of data indicated as ride request evaluation data 114 may include information pertaining to the driver 105, such as a number of rides that the driver 105 has accepted over a period of time, a number of rides that the driver 105 has declined over the period of time, a target number of rides that is a part of an incentive bonus scheme offered by the ride service operator 120, and a count of the number of rides required to meet or exceed the target number of rides.

One or more computers of the computer system 121 that is used by the ride service operator 120 may include several components such as a processor 122 and a memory 123. The memory 123, which is another example of a non-transitory computer-readable medium, may be used to store an operating system (OS) 127, a database 126, and various code modules such as a ride request evaluation system 124, and a customer communications module 128. The customer communications module 128 is configured for providing communications between the ride service operator 120 and various customers such as an exemplary customer 155. The customer 155 may use a device 156 such as a smartphone or a tablet to make a ride request to the ride service operator 120. The ride service operator 120 receives the ride request and passes on the ride request to one or more drivers such as the driver 105.

In one exemplary implementation in accordance with the disclosure, the ride request evaluation system 124 provided in the computer system 121 may be omitted, and the ride request originated by the customer 155 is evaluated by the ride request evaluation system 113 located in the device 110 of the driver 105. The evaluation is carried out by the ride request evaluation system 113 under control of the driver 105 in order to determine a profitability or a loss associated with accepting the ride request. In some cases, multiple drivers (in addition to the driver 105) may carry out an evaluation of the ride request, and one or more of the drivers may opt to either accept the ride request or decline the ride request based on their individual needs and circumstances.

In another exemplary implementation in accordance with the disclosure, the ride request evaluation system 113 provided in the device 110 of the driver 105 may be omitted, and the ride request originated by the customer 155 is evaluated by the ride request evaluation system 124 located in the computer system 121. The evaluation may be carried out by the ride service operator 120 on behalf of one or more drivers such as the driver 105, in order to assist the drivers in determining a profitability or a loss associated with accepting the ride request. This configuration eliminates or reduces some burdens such as cost, maintenance, and upgrades that may come into effect when individual drivers have to buy, install, and/or operate on their individual devices, one or more software programs associated with the ride request evaluation system 113.

In yet another exemplary implementation in accordance with the disclosure, the ride request evaluation system 124 provided in the computer system 121 may cooperatively operate with the ride request evaluation system 113 provided in the device 110 of the driver 105 to evaluate the ride request originated by the customer 155. For example, the ride request evaluation system 124 may execute certain functionalities that are applicable to multiple drivers, such as evaluating the ride request in view of the incentive bonus offered to the various drivers. The ride request evaluation system 113 provided in the device 110 may be cooperatively used to execute various other functionalities that may be unique to the driver 105, such as determining a distance between a current location of the driver 105 and the customer 155, and other factors such as a financial need of the driver 105 at the time of receiving the ride request.

A diagnostics module 145 may be installed in the ride automobile 150 and used to obtain various types of data pertaining to an operational condition of the ride automobile 150. For example, the diagnostics module 145 may be communicatively coupled to a computer (not shown) that is a part of the ride automobile 150 used for carrying out car-related operations such as fuel injection, engine performance monitoring, engine diagnostics, and alarms. The diagnostics module 145 may obtain from the computer, information such as a fuel consumption characteristic of the ride automobile 150, pending alarms, pending service events, pending repair events, tire tread condition, and fluids condition. The diagnostics module 145 may communicate with the computer system 121 of the ride service operator 120 to assist with the operation of the ride request evaluation system 124 and/or may communicate with the device 110 of the driver 105 to assist with the operation of the ride request evaluation system 113. The diagnostics module 145 may communicate with the computer system 121 through the network 130 and/or communicate with the device 110 via Bluetooth®, for example. In some cases, the communications may be carried out in machine-to-machine form without human intervention. In some other cases, machine-to-machine communications between the diagnostics module 145 and the computer system 121 (and/or the device 110) may be complemented by human-to-machine communications (voice-controlled applications), or by human-to-human communications between the driver 105 and the ride service operator 120.

A memory device such as the memory 123 and the memory 112 shown in FIG. 1 can include any one memory element or a combination of volatile memory elements (e.g., random-access memory (RAM, such as DRAM, SRAM, SDRAM, etc.)) and non-volatile memory elements (e.g., ROM, hard drive, tape, CDROM, etc.). Moreover, the memory device may incorporate electronic, magnetic, optical, and/or other types of storage media. In the context of this document, a “non-transitory computer-readable medium” can be, for example, but not limited to, an electronic, magnetic, optical, electromagnetic, infrared, or semiconductor system, apparatus, or device. More specific examples (a non-exhaustive list) of the computer-readable medium would include the following: a portable computer diskette (magnetic), a random-access memory (RAM) (electronic), a read-only memory (ROM) (electronic), an erasable programmable read-only memory (EPROM, EEPROM, or Flash memory) (electronic), and a portable compact disc read-only memory (CD ROM) (optical). Note that the computer-readable medium could even be paper or another suitable medium upon which the program is printed, because the program can be electronically captured, for instance, via optical scanning of the paper or other medium, then compiled, interpreted or otherwise processed in a suitable manner if necessary, and then stored in a computer memory.

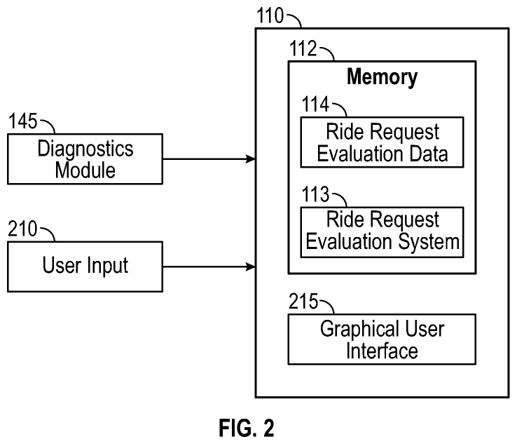

FIG. 2 shows a few exemplary functional blocks of the device 110 in accordance with an embodiment of the disclosure. The exemplary functional blocks include the ride request evaluation system 113, the ride request evaluation data 114, and a graphical user interface 215. The ride request evaluation system 113 may be utilized when a ride request is received in the device 110. The ride request may have been provided to the device 110 via the network 130 from the computer system 121 of the ride service operator 120 and/or from the device 156 operated by the customer 155. The driver 105 can view the ride request on the graphical user interface 215 and can decide whether to accept the ride request or to decline the ride request. The decision to do so may be assisted by the ride request evaluation system 113, which evaluates a profitability or a loss associated with accepting the ride request.

The evaluating process may be based at least in part on a cost factor that is calculated using various parameters including data stored in the form of the ride request evaluation data 114. A few examples of parameters that may be used for carrying out the evaluation include a distance to a destination indicated in the ride request, a time of day for executing the ride request, a fuel consumption rate of the ride automobile 150, and/or an operational condition of the ride automobile 150. The distance to the destination can be obtained by the device 110 from various sources such as a Global Positioning System (GPS) device located in the ride automobile 150 or via a map service offered on the Internet (when the network 130 includes the Internet). The time of day parameter may be obtained by the device 110 from various sources such as a clock installed in the device 110, or a timing signal received through the network 130. The ride request evaluation system 113 may use the time of day parameter to determine if the ride is to be provided during a peak hour period during which traffic congestion is higher than during other times of the day. An increase in traffic congestion adversely affects the profitability associated with accepting the ride request. The fuel consumption rate of the ride automobile 150 and/or an operational condition of the ride automobile 150 may be obtained from various sources such as from the diagnostics module 145, a trip computer in the ride automobile 150, or from the ride request evaluation data 114 stored in the memory 112.

The result of the evaluation by the ride request evaluation system 113 may be displayed on the graphical user interface 215. In one exemplary implementation, the result of the evaluation may be provided in the form of an advice to either accept or decline the ride request. In another exemplary implementation, the result of the evaluation may be provided in the form of a detailed listing of various factors that may assist the driver 105 in making a decision. The driver 105 may use the user input 210 to indicate his/her decision, for example, by accepting the ride request. The device 110 may transmit the decision to the ride service operator 120 and/or the customer 155.

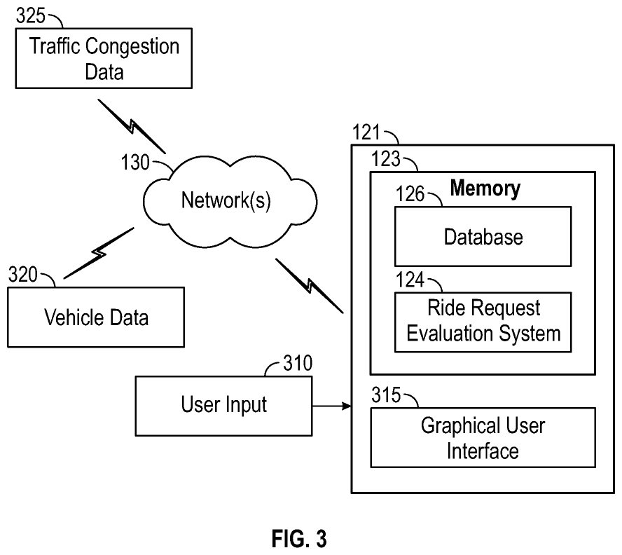

FIG. 3 shows some exemplary functional blocks of the computer system 121 used by the ride service operator 120. In one exemplary embodiment, the computer system 121 may include at least one computer that is configured to operate as a server. The exemplary functional blocks of the computer system 121 include the database 126, the ride request evaluation system 124, and a graphical user interface 315. The ride request evaluation system 124 is utilized when a ride request is received in the computer system 121. The ride request may have been provided to the computer system 121 via the network 130 from the device 156 operated by the customer 155. The ride request evaluation system 124 evaluates a profitability or a loss associated with accepting the ride request in order to provide assistance to one or more drivers such as the driver 105, in making a decision on whether to accept the ride request or decline the ride request.

The evaluating process may be based at least in part on a cost factor that is calculated using various parameters including data stored in the database 126. A few examples of parameters that may be stored in the database 126 may include statistics related to the driver 105 such as, for example, a number of rides that have been accepted by the driver 105 over a period of time, a number of rides that have been declined by the driver 105 over the period of time, details of an incentive bonus scheme offered by the ride service operator 120 to the driver 105, and whether the driver 105 is close to achieving the incentive bonus. Other parameters that may be used by the ride request evaluation system 124 for carrying out the evaluation may further include a distance to a destination indicated in the ride request, a time of day for executing the ride request, a fuel consumption rate of the ride automobile 150, and/or an operational condition of the ride automobile 150.

The distance to the destination can be obtained in the computer system 121 from various sources such as a map service offered on the Internet. The time of day parameter may be obtained by the computer system 121 from various sources such as a timing signal received through the network 130. The ride request evaluation system 124 may use the time of day parameter to determine if the ride is to be provided during a peak hour period during which traffic congestion is higher than during other times of the day. An increase in traffic congestion adversely affects the profitability associated with accepting the ride request. Traffic congestion data 325 may also be obtained from various sources such as a database maintained and operated by a city transport utility. The fuel consumption rate of the ride automobile 150 and/or an operational condition of the ride automobile 150 may be obtained from various sources such as from the diagnostics module 145 or a trip computer in the ride automobile 150. The operational condition of the ride automobile 150 may be obtained from a database containing vehicle data 320.

The result of the evaluation by the ride request evaluation system 124 may be displayed on the graphical user interface 315 and/or transmitted to the device 110 of the driver 105. In one exemplary implementation, the result of the evaluation may be provided in the form of an advice to the driver 105 to either accept or decline the ride request. In another exemplary implementation, the result of the evaluation may be provided to the driver 105 in the form of a detailed listing of various factors that may assist the driver 105 in making a decision. The driver 105 may provide user input 310 to the computer system 121 by using an input device such as a keyboard, a touchscreen, and/or a mouse.

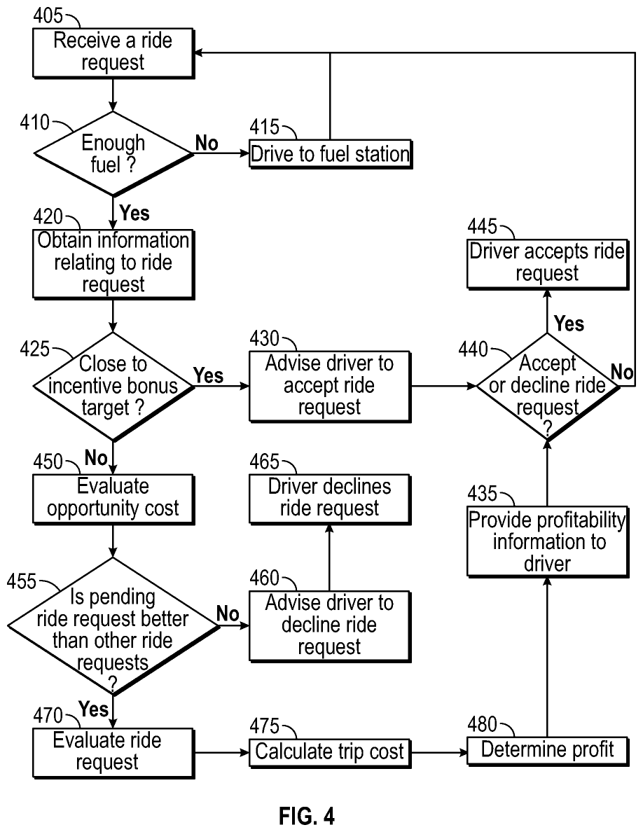

FIG. 4 shows a flowchart 400 that illustrates an exemplary method for evaluating a ride request in accordance with an embodiment of the disclosure. The flowchart 400 illustrates a sequence of operations that can be implemented in hardware, software, or a combination thereof. In the context of software, the operations represent computer-executable instructions stored on one or more non-transitory computer-readable media such as the memory 123 and the memory 112, that, when executed by one or more processors such as the processor 122 and the processor 111, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be carried out in a different order, omitted, combined in any order, and/or carried out in parallel. Some or all of the operations described in the flowchart 400 may be carried out by using an application executed on the device 110 and/or the computer system 121.

At block 405, a ride request may be received from the customer 155. The device 156 may be used by the customer 155 to send in, or call in, the ride request to the ride service operator 120 and/or to the driver 105. At block 410, a determination may be made on whether the ride automobile 150 has enough fuel to service the ride request. If the quantity of fuel is insufficient to service the ride request, the driver 105 is advised to drive to a fuel station at block 415. The driver 105 can respond to the advice by driving to the fuel station and obtaining adequate fuel before further considering the ride request at block 405. If the quantity of fuel is sufficient to service the ride request, at block 420, information may be obtained in connection with the ride request. For example, the driver 105 may request the ride service operator 120 to provide information such as an amount of money that will be paid to the driver 105 for executing the ride and/or a current status of the driver 105 with respect to an incentive bonus.

At block 425, a determination may be made on whether the driver 105 is close to achieving an incentive bonus. In an example implementation, an incentive bonus may involve the driver 105 providing “x” number of rides within a certain period of time (a week, for example). The driver 105 may have provided “y” rides as of the time of determination indicated by block 425. The evaluation procedure can include calculating a “z” value by which the driver 105 is falling short of the target “x” number of rides. The “z” value is then compared against a threshold value to determine if the driver 105 is close enough to achieving the incentive bonus that the financial profitability associated with accepting the ride request becomes a secondary consideration. The evaluation procedure may be illustrated by an example wherein x=100 and y=99. Using the equation x-y=z determines that the driver 105 is falling short of the target number of rides (100) by just 1 ride. Consequently, it would be beneficial for the driver 105 to accept the ride request even if doing so causes a financial loss on that particular ride. The financial loss may be more than offset by the incentive bonus wherein the driver 105 would receive a larger amount of money for achieving the target number of rides (100 in this example).

If close to receiving the incentive bonus as described above, at block 430, the driver 105 is advised to accept the ride request. At block 440, the driver 105 may make a determination on whether to accept or decline the ride request. The operation moves to block 445 if the driver 105 decides to accept the ride request and confirms acceptance of the ride request. However, if the driver 105 decides to decline the ride request at block 440, the operation returns to block 405.

Turning back to block 425, if the driver 105 is not close to achieving the incentive bonus, the operation moves to block 450, in which an evaluation may be carried out to determine an opportunity cost. The evaluation may be carried out by comparing the pending request to any of one or more other requests that are available at the current instant in time. The comparison may include, for example, evaluating various characteristics of a route associated with the pending ride request against characteristics of routes associated with other ride requests. The comparison may also include verifying whether a return trip is guaranteed for the pending ride request and/or for other ride requests.

At block 455, a determination may be made on whether it is better to accept the pending ride request or to wait for other ride requests. If it is not better to accept the pending ride request, a recommendation is made to the driver 105 at block 460 to decline the ride request. The recommendation operation is followed by block 465 in which the driver 105 declines the ride request.

On the other hand, if it is better to accept the pending ride request, at block 470, the ride request evaluation system 124 in the computer system 121 and/or the ride request evaluation system 113 in the device 110 operated by the driver 105 may fetch various parameters such as vehicle operational parameters, vehicle maintenance parameters, fuel level, and traffic conditions.

At block 475, a trip cost for the pending ride request may be calculated. The trip cost may be determined using various parameters such as fuel cost and vehicle operational parameters. At block 480, a profit may be determined based on the trip cost and factors such as financial benefits with respect to the customer 155 (fare, tips, etc.) and/or the ride service operator 120 (wages, flat fee, etc.).

At block 435, the profit information may be provided to the driver 105 based on the determination made in block 480 and advice to the driver 105 in accordance with the profit information. At block 440, the driver 105 may determine whether to accept or decline the advice. The operation moves to block 445 if the driver 105 decides to accept the ride request and confirms acceptance of the ride request. However, if the driver decides to turn down the trip request at block 440, the operation returns to block 405.

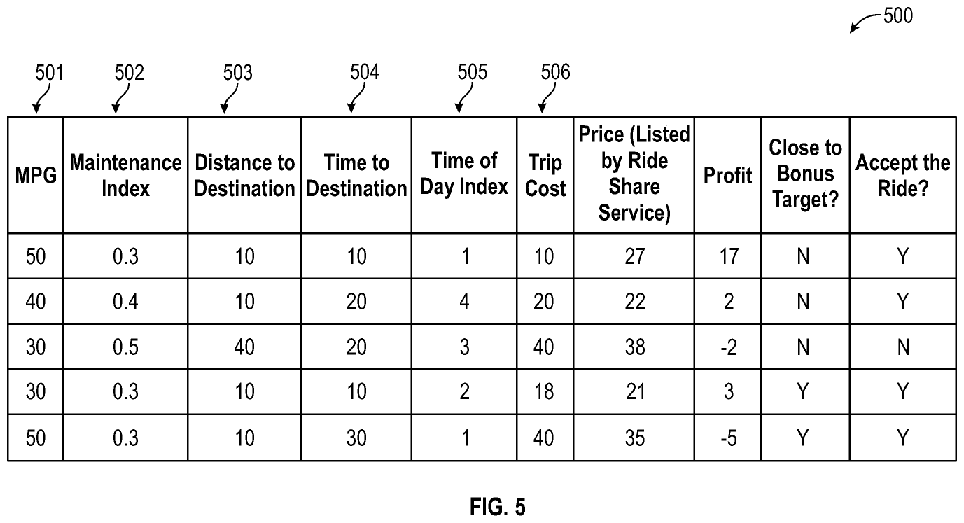

FIG. 5 shows a table 500 of various exemplary parameters that may be utilized by a ride request evaluation system in accordance with an embodiment of the disclosure. For example, some or all of the parameters indicated in table 500 may be used to calculate a cost factor. In general, the cost factor is directly proportional to a first set of parameters such as the fuel consumption rate of the ride automobile and the operational condition of the ride automobile, and is inversely proportional to a second set of parameters such as the distance to the destination indicated in the ride request and the time of day for executing the ride request.

For example, with respect to table 500, the cost factor is directly proportional to the fuel consumption rate which is represented in miles per gallon (MPG) in column 501, and an operational condition of the ride automobile 150, which is represented in this example, by a first numerical index (maintenance index) shown in column 502. The first numerical index is determined at least in part by a service record, a maintenance record, a model of the ride automobile, and/or a year of manufacture of the ride automobile. The cost factor is inversely proportional to parameters such as a distance to destination (column 503), time to destination (column 504), time of day index (column 505), and/or trip cost (column 506). The time of day index, which may be a second numerical index, is based on peak hour traffic congestion. In this example, the peak hour index is indicated by a numerical value that is smaller during peak hour traffic (thereby increasing the adverse impact on the cost factor) than during non-rush hour times of the day (thereby reducing the adverse impact upon the cost factor).

In one exemplary embodiment, the cost factor may be calculated by using the following generalized equation incorporating parameters such as those shown in table 500:

$$\text{Cost factor} = \frac{( W 1 \times MPG ) + ( W 2 \times \text{Maintenance Index} )}{\begin{matrix}( W 3 \times \text{Distance} ) + ( W 4 \times \text{Time to Destination} ) + \\ ( W 5 \times \text{time of day index} ) + ( W 6 \times \text{Trip cost} )\end{matrix}}$$

where W1 through W6 are weighting parameters that may be used to provide weighting to the various parameters. In one exemplary embodiment, weighting parameters such as W1 through W6 may be learned over time by using a machine learning model. The machine learning model may be included in the computer system 121 and/or the device 110, for example.

### Example Embodiments

In some instances, the following examples may be implemented together or separately by the systems and methods described herein.

Example 1 may include a method comprising: receiving, by a computer comprising at least one processor coupled to at least one memory, a ride request; determining, by the computer and based at least in part on a cost factor that is calculated using at least one of a distance to a destination indicated in the ride request, a time of day for executing the ride request, a fuel consumption rate of a ride automobile, and an operational condition of the ride automobile, one of a profitability or a loss associated with accepting the ride request; and providing a result of the determination to a device operated by a driver of the ride automobile.

Example 2 may include the method of example 1, wherein the cost factor is directly proportional to a first set of parameters comprising the fuel consumption rate of the ride automobile and the operational condition of the ride automobile, and inversely proportional to a second set of parameters comprising the distance to the destination indicated in the ride request and the time of day for executing the ride request.

Example 3 may include the method of example 2 and/or some other example herein, wherein the operational condition of the ride automobile is represented by a first numerical index, and the time of day for executing the ride request is represented by a second numerical index.

Example 4 may include the method of example 3 and/or some other example herein, wherein the first numerical index is determined at least in part by one or more of a service record, a maintenance record, a model of the ride automobile, and a year of manufacture of the ride automobile.

Example 5 may include the method of example 2 and/or some other example herein, wherein evaluating one of the profitability or the loss associated with accepting the ride request is further based on a threshold value associated with an incentive bonus provided to the driver by an operator of a ride service.

Example 6 may include the method of example 5 and/or some other example herein, wherein providing the result of the evaluation to the driver of the ride automobile enables the driver to decide on one of accepting or rejecting the ride request.

Example 7 may include a system comprising: at least one memory that stores computer-executable instructions; and at least one computer comprising at least one processor configured to access the at least one memory and executing the computer-executable instructions to at least: receive, by the at least one computer, a ride request; determine, by the at least one processor, based at least in part on a calculation that includes at least one of a distance to a destination indicated in the ride request, a time of day for executing the ride request, a fuel consumption rate of a ride automobile, and an operational condition of the ride automobile, a cost factor associated with accepting the ride request; and provide, to a device operated by a driver of the ride automobile, based at least on the cost factor, advice to either accept or reject the ride request.

Example 8 may include the system of example 7, wherein the at least one computer is one of a first computer operated by a provider of a ride service or a second computer operated by the driver of the ride automobile.

Example 9 may include the system of example 8 and/or some other example herein, wherein the second computer is located in one of a smartphone or a tablet and wherein the cost factor is provided to the driver via a graphical user interface of an application executed in the one of the smartphone or the tablet.

Example 10 may include the system of example 8 and/or some other example herein, wherein the ride automobile comprises: a diagnostics module configured to provide to the second computer, data indicative of the operational condition of the ride automobile.

Example 11 may include the system of example 10 and/or some other example herein, wherein the data indicative of the operational condition of the ride automobile comprises one or more of a service record, a maintenance record, a model of the ride automobile, and a year of manufacture of the ride automobile.

Example 12 may include the system of example 10 and/or some other example herein, wherein the second computer is further configured to determine an amount of fuel present in a fuel tank of the ride automobile and to instruct the driver to drive to a fuel station prior to determining the cost factor associated with accepting the ride request.

Example 13 may include a method comprising: receiving, by at least one computer comprising at least one processor coupled to at least one memory, a ride request; determining, by the at least one processor, one of a profitability or a loss associated with accepting the ride request; and providing, by the at least one processor to a device of a driver of a ride automobile and based on one of the profitability or the loss associated with accepting the ride request, an advice to either accept the ride request or decline the ride request.

Example 14 may include the method of example 13, wherein one of the profitability or the loss is based at least in part on a cost factor that is directly proportional to at least one of a fuel consumption rate of the ride automobile or an operational condition of the ride automobile, and inversely proportional to at least one of a distance to a destination indicated in the ride request and a time of day for executing the ride request.

Example 15 may include the method of example 14 and/or some other example herein, wherein the operational condition of the ride automobile is represented by a first numerical index, and the time of day for executing the ride request is represented by a second numerical index.

Example 16 may include the method of example 15 and/or some other example herein, wherein the first numerical index is determined at least in part by one or more of a service record, a maintenance record, a model of the ride automobile, and a year of manufacture of the ride automobile.

Example 17 may include the method of example 15 and/or some other example herein, wherein the first numerical index has a higher value when the time of day for executing the ride request occurs during peak traffic hours than during other hours.

Example 18 may include the method of example 14 and/or some other example herein, wherein one of the profitability or the loss associated with accepting the ride request is further based on a threshold value associated with an incentive bonus provided to the driver by an operator of a ride service.

Example 19 may include the method of example 18 and/or some other example herein, wherein the incentive bonus is defined at least in part by a number of ride requests accepted by the driver over a period of time.

Example 20 may include the method of example 14 and/or some other example herein, wherein one of the profitability or the loss associated with accepting the ride request is further based on comparing the cost factor to a fare payable towards the ride request.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, one skilled in the art will recognize such feature, structure, or characteristic in connection with other embodiments whether or not explicitly described.

Implementations of the systems, apparatuses, devices, and methods disclosed herein may comprise or utilize one or more devices that include hardware, such as, for example, one or more processors and system memory, as discussed herein.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or any combination of hardwired or wireless) to a computer, the computer properly views the connection as a transmission medium. Transmission media can include a network and/or data links, which can be used to carry desired program code means in the form of computer-executable instructions or data structures and which can be accessed by a general purpose or special purpose computer. Combinations of the above should also be included within the scope of non-transitory computer-readable media.

Computer-executable instructions comprise, for example, instructions and data which, when executed at a processor, cause the processor to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the present disclosure may be practiced in network computing environments with many types of computer system configurations, including in-dash vehicle computers, personal computers, desktop computers, laptop computers, message processors, handheld devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by any combination of hardwired and wireless data links) through a network, both perform tasks. In a distributed system environment, program modules may be located in both the local and remote memory storage devices.

Further, where appropriate, the functions described herein can be performed in one or more of hardware, software, firmware, digital components, or analog components. For example, one or more application specific integrated circuits (ASICs) can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

At least some embodiments of the present disclosure have been directed to computer program products comprising such logic (e.g., in the form of software) stored on any computer-usable medium. Such software, when executed in one or more data processing devices, causes a device to operate as described herein.

While various embodiments of the present disclosure have been described above, it should be understood that they have been presented by way of example only, and not limitation. It will be apparent to persons skilled in the relevant art that various changes in form and detail can be made therein without departing from the spirit and scope of the present disclosure. Thus, the breadth and scope of the present disclosure should not be limited by any of the above-described exemplary embodiments but should be defined only in accordance with the following claims and their equivalents. The foregoing description has been presented for the purposes of illustration and description. It is not intended to be exhaustive or to limit the present disclosure to the precise form disclosed. Many modifications and variations are possible in light of the above teaching. Further, it should be noted that any or all of the aforementioned alternate implementations may be used in any combination desired to form additional hybrid implementations of the present disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. A method comprising:
receiving, by a computer comprising at least one processor coupled to at least one memory, a ride request;
determining, by the computer and based at least in part on a cost factor that is calculated using at least one of a distance to a destination indicated in the ride request, a time of day for executing the ride request, a fuel consumption rate of a ride automobile, and an operational condition of the ride automobile, one of a profitability or a loss associated with accepting the ride request; and
providing a result of the determination to a device operated by a driver of the ride automobile.

2. The method of claim 1, wherein the cost factor is directly proportional to a first set of parameters comprising the fuel consumption rate of the ride automobile and the operational condition of the ride automobile, and inversely proportional to a second set of parameters comprising the distance to the destination indicated in the ride request and the time of day for executing the ride request.

3. The method of claim 2, wherein the operational condition of the ride automobile is represented by a first numerical index, and the time of day for executing the ride request is represented by a second numerical index.

4. The method of claim 3, wherein the first numerical index is determined at least in part by one or more of a service record, a maintenance record, a model of the ride automobile, and a year of manufacture of the ride automobile.

5. The method of claim 2, wherein evaluating one of the profitability or the loss associated with accepting the ride request is further based on a threshold value associated with an incentive bonus provided to the driver by an operator of a ride service.

6. The method of claim 5, wherein providing the result of the evaluation to the driver of the ride automobile enables the driver to decide on one of accepting or rejecting the ride request.

7. A system comprising:
at least one memory that stores computer-executable instructions; and
at least one computer comprising at least one processor configured to access the at least one memory and executing the computer-executable instructions to at least:
receive, by the at least one computer, a ride request;
determine, by the at least one processor, based at least in part on a calculation that includes at least one of a distance to a destination indicated in the ride request, a time of day for executing the ride request, a fuel consumption rate of a ride automobile, and an operational condition of the ride automobile, a cost factor associated with accepting the ride request; and
provide, to a device operated by a driver of the ride automobile, based at least on the cost factor, advice to either accept or reject the ride request.

8. The system of claim 7, wherein the at least one computer is one of a first computer operated by a provider of a ride service or a second computer operated by the driver of the ride automobile.

9. The system of claim 8, wherein the second computer is located in one of a smartphone or a tablet and wherein the cost factor is provided to the driver via a graphical user interface of an application executed in the one of the smartphone or the tablet.

10. The system of claim 8, wherein the ride automobile comprises:
a diagnostics module configured to provide to the second computer, data indicative of the operational condition of the ride automobile.

11. The system of claim 10, wherein the data indicative of the operational condition of the ride automobile comprises one or more of a service record, a maintenance record, a model of the ride automobile, and a year of manufacture of the ride automobile.

12. The system of claim 10, wherein the second computer is further configured to determine an amount of fuel present in a fuel tank of the ride automobile and to instruct the driver to drive to a fuel station prior to determining the cost factor associated with accepting the ride request.

13. A method comprising:
receiving, by at least one computer comprising at least one processor coupled to at least one memory, a ride request;
determining, by the at least one processor, one of a profitability or a loss associated with accepting the ride request; and
providing, by the at least one processor to a device of a driver of a ride automobile and based on one of the profitability or the loss associated with accepting the ride request, an advice to either accept the ride request or decline the ride request.

14. The method of claim 13, wherein one of the profitability or the loss is based at least in part on a cost factor that is directly proportional to at least one of a fuel consumption rate of the ride automobile or an operational condition of the ride automobile, and inversely proportional to at least one of a distance to a destination indicated in the ride request and a time of day for executing the ride request.

15. The method of claim 14, wherein the operational condition of the ride automobile is represented by a first numerical index, and the time of day for executing the ride request is represented by a second numerical index.

16. The method of claim 15, wherein the first numerical index is determined at least in part by one or more of a service record, a maintenance record, a model of the ride automobile, and a year of manufacture of the ride automobile.

17. The method of claim 15, wherein the first numerical index has a higher value when the time of day for executing the ride request occurs during peak traffic hours than during other hours.

18. The method of claim 14, wherein one of the profitability or the loss associated with accepting the ride request is further based on a threshold value associated with an incentive bonus provided to the driver by an operator of a ride service.

19. The method of claim 18, wherein the incentive bonus is defined at least in part by a number of ride requests accepted by the driver over a period of time.

20. The method of claim 14, wherein one of the profitability or the loss associated with accepting the ride request is further based on comparing the cost factor to a fare payable towards the ride request.
